(19) United States
(12) Patent Application Publication
(10) Pub. No.: US 2024/0296969 A1
(43) Pub. Date: Sep. 5, 2024

(54) TWO-DIMENSIONAL PARTICLE, CONDUCTIVE FILM, CONDUCTIVE PASTE, AND METHOD FOR PRODUCING TWO-DIMENSIONAL PARTICLE

(71) Applicant: Murata Manufacturing Co., Ltd., Nagaokakyo-shi (JP)

(72) Inventors: Masashi KOYANAGI, Nagaokakyo-shi (JP); Yoshinobu NAKANISHI, Nagaokakyo-shi (JP); Yuusuke OGAWA, Nagaokakyo-shi (JP)

(21) Appl. No.: 18/598,454

(22) Filed: Mar. 7, 2024

Related U.S. Application Data
(63) Continuation of application No. PCT/JP2022/034732, filed on Sep. 16, 2022.

(30) Foreign Application Priority Data
Sep. 24, 2021 (JP) 2021-155014

(51) Int. Cl. H01B 1/06; H01B 5/14

(52) U.S. Cl. CPC H01B 1/06; H01B 5/14

(57) ABSTRACT

A two-dimensional particle that includes: one or more layers, each of the one or more layers including a layer body represented by: MₘXₙ, wherein M is at least one Group 3, 4, 5, 6, or 7 metal, X is a carbon atom, a nitrogen atom, or a combination thereof, n is 1 to 4, m is more than n but not more than 5, a modifier or terminal T on a surface of the layer body, T is at least one of a hydroxy group, a fluorine atom, a bromine atom, an oxygen atom, a sulfur atom, Se, Te, and a hydrogen atom, and M of the one or more layers is bonded to at least one of PO₄³⁻ and SO₄²⁻; and a metal cation of metals in the third to fifth periods of the periodic table, and a content of Li is less than 0.002 mass %.

### CROSS REFERENCE TO RELATED APPLICATIONS

The present application is a continuation of International application No. PCT/JP2022/034732, filed Sep. 16, 2022, which claims priority to Japanese Patent Application No. 2021-155014, filed Sep. 24, 2021, the entire contents of each of which are incorporated herein by reference.

### TECHNICAL FIELD

The present invention relates to a two-dimensional particle, a conductive film, a conductive paste, and a method for producing a two-dimensional particle.

### BACKGROUND ART

In recent years, MXene has been attracting attention as a new material having conductivity. MXene is a type of so-called two-dimensional material, and as will be described later, is a layered material in the form of one or more layers. In general, MXene is in the form of particles (which can include powders, flakes, nanosheets, and the like) composed of such a layered material.

Currently, various studies are being conducted toward the application of MXene to various electrical devices. For the above application, it is required to further enhance the conductivity of materials containing MXene. As a part of the study thereof, a delamination treatment method of MXene obtained as a multilayered product has been studied.

Non-Patent Document 1 discloses that delamination treatment of multilayer MXene is performed by handshaking using tetramethylammonium hydroxide (TMAOH).

Non-Patent Document 2 also describes that Li cations derived from LiCl used in chemical etching exist in interlayer spaces of MXene, and that a structural change of the MXene powder occurs by exchanging the Li cations with other metal ions.
Non-patent Document 1: Mohamed Alhabeb et al., “Guidelines for Synthesis and Processing of Two-Dimensional Titanium Carbide (Ti3C2Tx MXene)” Chem. Mater. 2017, 29, 7633-7644
Non-patent Document 2: Michael Ghidiu et al., “Ion-Exchange and Cation Solvation Reactions in Ti3C2 MXene” Chem. Mater. 2016, 28, 10, 3507-3514

### SUMMARY OF THE INVENTION

In the MXene described in Non-Patent Document 1, the conductivity is low due to remaining TMAOH used for the delamination treatment of the multilayer MXene, and the conductivity further decreases due to moisture absorption, so that the reliability is not sufficiently satisfactory. Further, in the MXene described in Non-Patent Document 2, Li cations are exchanged with other metal ions, but since the MXene remains as a multilayer MXene, the conductivity is low, and since the MXene is a multilayer MXene, it is not easy to form a conductive film.

An object of the present invention is to realize a two-dimensional particle capable of providing a conductive film that can maintain high conductivity even under high humidity conditions. Another object of the present invention is to provide a method for producing such a two-dimensional particle.

<1> A two-dimensional particle comprising:
one or more layers, wherein each of the one or more layers includes a layer body represented by:

MₘXₙ
wherein M is at least one Group 3, 4, 5, 6, or 7 metal,
X is a carbon atom, a nitrogen atom, or a combination thereof,
n is not less than 1 and not more than 4, and
m is more than n but not more than 5; and
a modifier or terminal T is present on a surface of the layer body, wherein T is at least one selected from the group consisting of a hydroxy group, a fluorine atom, a chlorine atom, a bromine atom, an iodine atom, an oxygen atom, a sulfur atom, Se, Te, and a hydrogen atom,
wherein the M of the one or more layers is bonded to at least one selected from the group consisting of PO₄³⁻ and SO₄²⁻; and
a metal cation of metals in the third to fifth periods of the periodic table, and
wherein a content of Li in the two-dimensional particle is less than 0.002 mass %.

<2> The two-dimensional particle according to <1>, wherein the metal cation contains a cation of at least one metal selected from the group consisting of K, Na, Mg, Al, Mn, Ca, Fe, V, Cr, Co, Ni, Zn, Cu, and Sr.

<3> The two-dimensional particle according to <1> or <2>, wherein the metal cation contains a cation of at least one metal selected from the group consisting of K, Na, Mg, Al, Ca, and Sr.

<4> The two-dimensional particle according to any one of <1> to <3>, wherein the content of the Li in the two-dimensional particle is 0.0001 mass % or less.

<5> The two-dimensional particle according to any one of <1> to <4>, wherein a content of Al is 0.4 mass % or more.

<6> The two-dimensional particle according to any one of <1> to <5>, wherein an Al cation is present between the one or more layers.

<7> The two-dimensional particle according to any one of <1> to <6>, wherein an average thickness is not less than 1 nm and not more than 10 nm.

<8> The two-dimensional particle according to any one of <1> to <7>, wherein an average value of major diameters of two-dimensional surfaces is not less than 1 μm and not more than 20 μm.

<9> A conductive film comprising the two-dimensional particle according to any one of <1> to <8>.

<10> The conductive film according to <9>, wherein a conductivity is 2,000 S/cm or more.

<11> A conductive paste comprising the two-dimensional particle according to any one of <1> to <8> and a dispersion medium.

<12> A method for producing a two-dimensional particle, the method comprising:
(a) preparing a precursor represented by:

MₘAXₙ
wherein M is at least one Group 3, 4, 5, 6, or 7 metal,
X is a carbon atom, a nitrogen atom, or a combination thereof,
A is at least one group 12, 13, 14, 15, 16 element,
n is not less than 1 and not more than 4, and
m is more than n but not more than 5;
(b) performing an etching treatment for removing at least a part of the A atoms from the precursor using an etching liquid to obtain an etched product, wherein the etching liquid contains an anion containing at least one selected from the group consisting of a phosphorus atom, a sulfur atom, a chlorine atom, and an iodine atom;
(c) performing a first water washing treatment including washing the etched product with water to obtain a first water washed product;
(d) performing a first intercalation treatment including mixing the first water washed product with a metal-containing compound to obtain a first intercalated product, wherein the metal-containing compound contains at least one of cations of metals in the third to fifth periods of the periodic table;
(e) performing a second water washing treatment including washing the first intercalated product with water to obtain a second water washed product;
(f) performing a second intercalation treatment including mixing the second water washed product with an organic compound to obtain a second intercalated product, wherein a solubility of the organic compound in water is 5 g/100 gH₂O or more at 25° C.; and
(g) performing a delamination treatment including stirring the second intercalated product to obtain a two-dimensional particle.

<13> The method for producing a two-dimensional particle according to <12>, wherein the delamination treatment includes stirring the second intercalated product in the presence of PO₄³⁻.

<14> The method for producing a two-dimensional particle according to <12> or <13>, wherein a Hildebrand solubility parameter of the organic compound is not less than 19.0 MPa^{1/2} and not more than 47.8 MPa^{1/2}.

According to the present invention, it is possible to realize a two-dimensional particle that can maintain high conductivity even under high humidity conditions. Further, according to the present invention, a method for producing such a two-dimensional particle can be provided.

### BRIEF DESCRIPTION OF THE DRAWINGS

FIGS. 1(a) and 1(b) are schematic cross-sectional views illustrating MXene particles composed of a layered material in one embodiment of the present invention, FIG. 1(a) illustrates a single-layer MXene particle, and FIG. 1(b) illustrates a multilayer (exemplarily, two-layer) MXene particle.

FIG. 2 is a schematic cross-sectional view illustrating a conductive film according to one embodiment of the present invention.

### DETAILED DESCRIPTION OF THE PREFERRED EMBODIMENTS

### Embodiment 1: Two-Dimensional Particle

Hereinafter, a two-dimensional particle in one embodiment of the present invention will be described in detail, but the present invention is not limited to such an embodiment.

The two-dimensional particle in the present embodiment is a two-dimensional particle composed of a layered material having one or more layers, and contains a metal cation.

The layer includes:
a layer body (the layer body optionally has a crystal lattice in which each X is located in an octahedral array of M) represented by the following formula:

MₘXₙ
in which M is at least one Group 3, 4, 5, 6, or 7 metal,
X is a carbon atom, a nitrogen atom, or a combination thereof,
n is not less than 1 and not more than 4, and
m is more than n but not more than 5; and
a modifier or terminal T (T is at least one selected from the group consisting of a hydroxy group, a fluorine atom, a chlorine atom, a bromine atom, an iodine atom, an oxygen atom, a sulfur atom, Se, Te, and a hydrogen atom) present on a surface of the layer body (more specifically, at least one of the two surfaces facing each other in the layer body), and
the modifier or terminal T contains a chlorine atom, or M of the layer is bonded to at least one selected from the group consisting of PO₄³⁻, I, and SO₄²⁻.

In the present specification, when a certain element is referred to as an “atom”, the oxidation number of the element is not limited to zero, and may be any number within the range of possible oxidation numbers of the element.

The layered material can be understood as a layered compound, and is also denoted as “MₘXₙTₛ”, in which s is any number, and conventionally x or z may be used instead of s. Typically, n can be 1, 2, 3, or 4, but is not limited thereto.

In the above formula of MXene, M is preferably at least one selected from the group consisting of Ti, Zr, Hf, V, Nb, Ta, Cr, Mo, Sc, Y, W, and Mn, more preferably Ti, Zr, Hf, V, Nb, Ta, Cr, Mo, and Mn, and still more preferably at least one selected from the group consisting of Ti, V, Cr, and Mo.

MXenes whose above formula MₘXₙ is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (in the above formula, “1.3” and “0.6” mean about 1.3 (=4/3) and about 0.6 (=2/3), respectively);
Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂, Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo,V)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃ (in the above formula, “2.7” and “1.3” mean about 2.7 (=8/3) and about 1.3 (=4/3), respectively); and (Mo,V)₅C₄.

Typically in the above formula, M can be titanium or vanadium and X can be a carbon atom or a nitrogen atom. For example, the MAX phase is Ti₃AlC₂ and MXene is Ti₃C₂ Tₛ (in other words, M is Ti, X is C, n is 2, and m is 3).

T may be preferably at least one selected from the group consisting of a hydroxy group, a fluorine atom, a chlorine atom, an oxygen atom, and a hydrogen atom.

It is noted, in the present invention, MXene may contain A atoms derived from the MAX phase as a precursor at a relatively small amount, for example, at 10 mass % or less with respect to the original amount of A atoms. The remaining amount of A atoms can be preferably 8 mass % or less, and more preferably 6 mass % or less. However, even if the remaining amount of A atoms exceeds 10 mass %, there may be no problem depending on the application and use conditions of the two-dimensional particle.

In the present specification, the above layer may be referred to as an MXene layer, and the two-dimensional particle may be referred to as an MXene two-dimensional particle or an MXene particle.

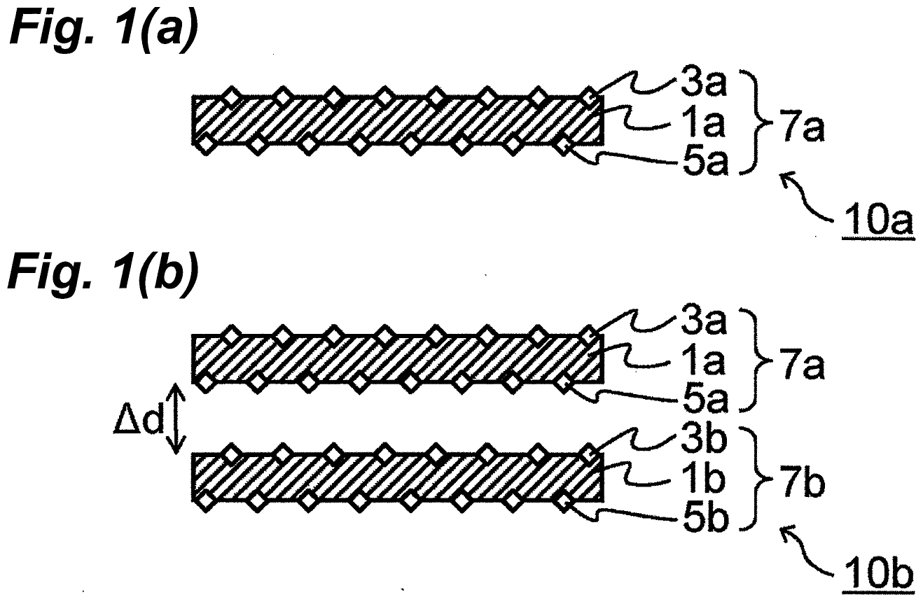

The two-dimensional particle of the present embodiment is an aggregate including an MXene particle 10a of one layer (single-layer MXene particle) (hereinafter, simply referred to as “MXene particle”) schematically exemplified in FIG. 1(a). More specifically, the MXene particle 10a is an MXene layer 7a having a layer body (MₘXₙ layer) la represented by MₘXₙ and modifiers or terminals T 3a, 5a present on the surface of the layer body 1a (more specifically, on at least one of two surfaces facing each other in each layer). Therefore, the MXene layer 7a is also represented by “MₘXₙTₛ”, in which s is any number.

In FIG. 1(a), metal cations are not shown.

The two-dimensional particle of the present embodiment may include one or more layers. Examples of the MXene particle of a plurality of layers (multilayer MXene particle) include, but are not limited to, a MXene particle 10b of two layers as schematically shown in FIG. 1(b). 1b, 3b, 5b, and 7b in FIG. 1 (b) are the same as 1a, 3a, 5a, and 7a in FIG. 1(a) described above. Two adjacent MXene layers (e.g., 7a and 7b) in the multilayer MXene particle may not necessarily be completely separated from each other, but may be partially in contact with each other. The MXene particle 10a is present as one layer obtained by the multilayer MXene particle 10b being individually separated, and may be a mixture of the single-layer MXene particle 10a and the remaining multilayer MXene particle 10b that is not separated. In FIG. 1(b), metal cations are not shown.

Although the present embodiment is not limited, the thickness of each layer (corresponding to the MXene layers 7a, 7b) included in the MXene particle is, for example, not less than 0.8 nm and not more than 5 nm, particularly not less than 0.8 nm and not more than 3 nm (which may vary mainly depending on the number of M atom layers included in each layer). The interlayer distance (alternatively, void dimension, indicated by Δd in FIG. 1(b)) for individual laminates of the multilayer MXene particle that can be included may be, for example, not less than 0.8 nm and not more than 10 nm, particularly not less than 0.8 nm and not more than 5 nm, and more particularly about 1 nm, and the total number of layers may be not less than 2 and not more than 20,000.

In the two-dimensional particle of the present embodiment, the multilayer MXene particle that can be included is preferably an MXene particle having a small number of layers obtained through the delamination treatment. The term “small number of layers” described above means, for example, that the number of stacked MXene layers is 6 or less. In addition, the thickness of the multilayer MXene particle having a small number of layers in the stacking direction is preferably 15 nm or less, and more preferably 10 nm or less. Hereinafter, the “multilayer MXene particle having a small number of layers” may be referred to as “few-layer MXene particle”. The single-layer MXene particle and the few-layer MXene particle may be collectively referred to as “single-layer/few-layer MXene particle”.

The two-dimensional particle of the present embodiment preferably includes a single-layer MXene particle and a few-layer MXene particle, that is, a single-layer/few-layer MXene particle. In the two-dimensional particle of the present embodiment, the proportion of the single-layer/few-layer MXene particle having a thickness of 15 nm or less is preferably 90 vol % or more, and more preferably 95 vol % or more.

The metal cation contains at least one of cations of metals in the third to fifth periods of the periodic table. Examples of the metal of the third period of the periodic table include Na, Mg, Al, and Si. Examples of the metal of the fourth period of the periodic table include K, Ca, Sc, Ti, V, Cr, Mn, Fe, Co, Ni, Cu, Zn, Ga, Ge, and As. Examples of the metal of the fifth period of the periodic table include Rb, Sr, Y, Zr, Nb, Mo, Tc, Ru, Rh, Pd, Ag, Cd, In, Sn, Sb, and Te. The metal may be an alkali metal, an alkaline earth metal, a transition metal (metals of Groups 3 to 11 of the periodic table), or a main group metal (metals of Groups 12 to 16 of the periodic table). It is considered that the metal cations in the third to fifth periods of the periodic table are present between layers, and can interact with the layers because the ion sizes thereof are an appropriate size.

In one aspect, the metal cation preferably contains a cation of one selected from the group consisting of K, Na, Mg, Al, Mn, Ca, Fe, V, Cr, Co, Ni, Zn, Cu, and Sr, and more preferably contains a cation of one selected from the group consisting of K, Na, Mg, Al, Ca, and Sr.

In another aspect, the metal cation preferably contains a cation of one selected from the group consisting of K, Na, Mg, Mn, Ca, Fe, V, Cr, Co, Ni, Zn, Cu, and Sr, and more preferably contains a cation of one selected from the group consisting of K, Na, and Ca.

The valence of the metal cation may be monovalent or divalent or more, and preferably monovalent, divalent, or trivalent. It is considered that when the valence of the metal cation is divalent or more, the metal cation and the layer are likely to interact with each other, and two adjacent layers are attracted via the polyvalent metal cation, so that water is less likely to enter between the layers. It is therefore considered that it is easy to maintain high conductivity even under high temperature and high humidity.

The metal cation preferably does not contain a Li cation. The phrase “the metal cation does not contain a Li cation” means that the concentration of the Li cation is less than 20 ppm by mass in the total amount of the metal cation as measured by, for example, inductively coupled plasma atomic emission spectroscopy (ICP-AES).

The metal of the metal cation may be the same as or different from the metal contained in the MAX phase as a precursor. When the metal of the metal cation is different from the metal contained in the MAX phase as a precursor, it is easy to confirm the presence of the metal in the two-dimensional particle.

The metal cation is typically present on the layer. That is, the metal cation may be in contact with the layer, or may be present on the layer via another element.

The content of the metal cation in the two-dimensional particle (for example, the total of the layer and the metal cation) may be, for example, 20 mass % or less, further 10 mass % or less, especially 5 mass % or less, particularly 3 mass % or less, and may be, for example, 0.1 mass % or more, further 0.2 mass % or more.

The content of the metal cation can be measured by, for example, inductively coupled plasma atomic emission spectroscopy (ICP-AES) or the like.

It can be confirmed by measuring the surface of the two-dimensional particle by X-ray photoelectron spectroscopy (XPS) or the like that the modifier or terminal T includes a chlorine atom or that M of the layer is bonded to at least one selected from the group consisting of PO₄³⁻, I, and SO₄²⁻.

The two-dimensional particle of the present disclosure preferably contains an Al cation as a metal cation. Although not to be construed as being limited to a specific theory, it is considered that the Al cation is a trivalent metal cation and may interact more strongly with the layer which is negatively charged, as compared to monovalent or divalent metal cations. Therefore, it is considered that entry of moisture between the layers is suppressed, and high conductivity can be maintained even under high temperature and high humidity.

In one aspect, the Al cation is preferably present between the layers. As a result, it is considered that the interaction with the layer can be further strengthened, thereby making it possible to suppress entry of moisture between the layers, and high conductivity can be more reliably maintained even under high temperature and high humidity.

The presence of the Al cation between the layers can be confirmed by ²⁷Al NMR. For example, specifically, in a spectrum obtained by solid ²⁷Al NMR by the magic angle spinning+Hahn echo method, the presence of the Al cation can be confirmed by the presence of the peak, for example, preferably in a range of not less than 13 ppm and not more than 18 ppm.

The content of Al in the two-dimensional particle of the present disclosure may be preferably 0.4 mass % or more, more preferably not less than 0.4 mass % and not more than 12 mass %, more preferably not less than 0.4 mass % and not more than 5 mass %, and still more preferably not less than 0.4 mass % and not more than 1 mass %. The content of Al in the two-dimensional particle is based on the content of the Al cation contained as a metal cation, but may contain a residue of the A phase of the precursor.

The content of Al in the two-dimensional particle can be measured by inductively coupled plasma atomic emission spectroscopy (ICP-AES) or the like.

In the two-dimensional particle, the content of Li is suppressed. Therefore, when the two-dimensional particle is used, it is possible to provide a conductive film capable of maintaining high conductivity even under high humidity conditions, for example, under conditions of a relative humidity of 99%. The content of Li in the two-dimensional particle (for example, the total of the layer and the metal cation) is less than 0.002 mass %, preferably 0.001 mass % or less, and more preferably 0.0001 mass % or less.

The content of Li can be measured by, for example, inductively coupled plasma atomic emission spectroscopy (ICP-AES) or the like. The detection limit of Li measured by ICP-AES is 0.0001 mass %.

The two-dimensional particle of the present embodiment does not contain an amine. As described in Non-Patent Document 1, when delamination treatment of MXene is performed using TMAOH, the single-layer MXene is obtained, but TMAOH remains on the surface of the MXene layer even after washing to cause deterioration of the conductivity. Although TMAOH can be removed in a high temperature state of not lower than 250° C. and not higher than 500° C., MXene may be oxidized and decomposed in such a high temperature state. On the other hand, the two-dimensional particle of the present embodiment does not use TMAOH for delamination treatment of MXene, and does not contain an amine. The phrase “does not contain an amine” in the present specification means that triethylamine derived from TMAOH (m/z=42,53,54) is 10 ppm by mass or less as measured using a gas chromatography-mass spectrometry (GC-MS) apparatus.

In the present specification, the two-dimensional particle refers to a particle having a ratio of (average value of major diameters of two-dimensional surfaces of two-dimensional particles)/(average value of thicknesses of two-dimensional particles) of 1.2 or more, preferably 1.5 or more, and more preferably 2 or more. The average value of the major diameters of the two-dimensional surfaces of the two-dimensional particles, and the average value of the thicknesses of the two-dimensional particles may be obtained by the methods described later.

### (Average Value of Major Diameters of Two-Dimensional Surfaces of Two-Dimensional Particles)

In the two-dimensional particle of the present embodiment, the average value of the major diameters of the two-dimensional surfaces is not less than 1 μm and not more than 20 μm. Hereinafter, the average value of the major diameters of the two-dimensional surfaces may be referred to as “average flake size”.

As the average flake size is larger, the conductivity of the conductive film is larger. Since the two-dimensional particle of the present embodiment has a large average flake size of 1.0 μm or more, a film formed using the two-dimensional particle, for example, a film obtained by stacking the two-dimensional particles can achieve a conductivity of 2,000 S/cm or more. The average value of the major diameters of the two-dimensional surfaces is preferably 1.5 μm or more, and more preferably 2.5 μm or more. In Non-Patent Document 2, delamination treatment of MXene is performed by subjecting MXene to ultrasonic treatment. Since most of the major diameter of MXene is reduced to about several hundred nm by the ultrasonic treatment, a film formed of the single-layer MXene obtained in Non-Patent Document 2 is considered to have low conductivity.

The average value of the major diameters of the two-dimensional surfaces is 20 μm or less, preferably 15 μm or less, and more preferably 10 μm or less from the viewpoint of dispersibility in the dispersion medium.

As shown in Examples described later, the major diameter of the two-dimensional surface refers to a major diameter when each MXene particle is approximated to an elliptical shape in an electron micrograph, and the average value of the major diameters of the two-dimensional surfaces refers to a number average of the major diameters of 80 particles or more. As the electron microscope, a scanning electron microscope (SEM) photograph or a transmission electron microscope (TEM) photograph can be used.

The average value of the major diameters of the two-dimensional particles of the present embodiment may be measured by dissolving a conductive film containing the two-dimensional particles in a solvent, and dispersing the two-dimensional particles in the solvent. Alternatively, the average value of the major diameters of the two-dimensional particles may be measured from an SEM image of the conductive film.

### (Average Value of Thicknesses of Two-Dimensional Particles)

The average value of the thicknesses of the two-dimensional particles of the present embodiment is preferably not less than 1 nm and not more than 15 nm. The thickness is preferably 10 nm, more preferably 7 nm or less, and still more preferably 5 nm or less. On the other hand, considering the thickness of the single-layer MXene particle, the lower limit of the thickness of the two-dimensional particle can be 1 nm.

The average value of the thicknesses of the two-dimensional particles is obtained as a number average dimension (for example, a number average of at least 40 particles) based on an atomic force microscope (AFM) photograph or a transmission electron microscope (TEM) photograph.

### Embodiment 2: Method for Producing Two-Dimensional Particle

Hereinafter, a method for producing a two-dimensional particle according to an embodiment of the present invention will be described in detail, but the present invention is not limited to such an embodiment.

The method for producing a two-dimensional particle according to the present embodiment includes:
(a) preparing a predetermined precursor;
(b) performing an etching treatment for removing at least a part of the A atoms from the precursor using an etching liquid to obtain an etched product, wherein the etching liquid contains an anion containing at least one selected from the group consisting of a phosphorus atom, a sulfur atom, a chlorine atom, and an iodine atom;
(c) performing a first water washing treatment including washing the etched product with water to obtain a first water washed product;
(d) performing a first intercalation treatment including mixing the first water washed product with a metal-containing compound to obtain a first intercalated product, wherein the metal-containing compound contains at least one of cations of metals in the third to fifth periods of the periodic table;
(e) performing a second water washing treatment including washing the first intercalated product with water to obtain a second water washed product;
(f) performing a second intercalation treatment including mixing the second water washed product with an organic compound to obtain a second intercalated product, wherein a solubility of the organic compound in water is 5 g/100 gH₂O or more at 25° C.; and
(g) performing a delamination treatment including stirring the second intercalated product to obtain a two-dimensional particle.

Usually, when the intercalation treatment is performed using a metal-containing compound containing a metal cation in the third to fifth periods of the periodic table, delamination hardly proceeds because the absolute values of the hydration enthalpies of these metal cations are smaller than the absolute value of the hydration enthalpy of the Li ion. However, according to the study of the present inventors, even when a metal compound containing a metal cation other than the Li ion is used, by further performing an intercalation treatment using an organic compound having solubility in water, water easily enters between layers, and delamination can sufficiently proceed.

Hereinafter, each step will be described in detail.

### Step (a)

First, a predetermined precursor is prepared. The predetermined precursor that can be used in the present embodiment is a MAX phase that is a precursor of MXene, and is represented by the following formula:

MₘAXₙ
in which M is at least one Group 3, 4, 5, 6, or 7 metal,
X is a carbon atom, a nitrogen atom, or a combination thereof,
A is at least one Group 12, 13, 14, 15, or 16 element,
n is not less than 1 and not more than 4, and
m is more than n but not more than 5.

M, X, n, and m are as described in the first embodiment. A is at least one Group 12, 13, 14, 15, or 16 element, is usually a Group A element, typically Group IIIA and Group IVA, and more specifically may contain at least one selected from the group consisting of Al, Ga, In, Tl, Si, Ge, Sn, Pb, P, As, S, and Cd, and is preferably Al.

The MAX phase has a crystal structure in which a layer constituted of A atoms is located between two layers represented by MₘXₙ (each X may have a crystal lattice located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms. The A atom layer (and optionally a part of the M atoms) is removed by selectively etching (removing and optionally layer-separating) the A atoms (and optionally a part of the M atoms) from the MAX phase.

The MAX phase can be produced by a known method. For example, TiC powder, Ti powder, and Al powder are mixed in a ball mill, and the resulting mixed powder is calcined under an Ar atmosphere to obtain a calcined body (block-shaped MAX phase). Thereafter, the obtained calcined body is crushed by an end mill to obtain a powdery MAX phase for the next step.

In the present disclosure, a material having a layered structure similar to that of the MAX phase may be used as the precursor. Examples of such a material include Zr₂Al₃C₄, Zr₃Al₃C₅, Zr₄(AlC₂)₃, Zr₂Al₄C₅, Zr₂Al₃C₄, Zr₃Al₃C₅, and Zr₂Al₃C₅.

### Step (b)

In the step (b), an etching treatment for removing at least a part of the A atoms from the precursor is performed using an etching liquid.

The etching liquid contains an anion containing at least one selected from the group consisting of a phosphorus atom, a sulfur atom, a chlorine atom, and an iodine atom. As a result, a sufficient etching treatment becomes possible, and the metal cation is easily intercalated in the subsequent first intercalation treatment. The existence form of the anion is not particularly limited, and the anion may exist as an ion, may exist as an acid by being bonded to H⁺, or may exist as a salt by being bonded to a cation.

Examples of the anion containing a phosphorus atom include PO₄³⁻, examples of the anion containing a sulfur atom include SO₄²⁻, examples of the anion containing a chlorine atom include Cl⁻, and examples of the anion containing an iodine atom include I⁻.

The etching liquid preferably contains at least one selected from the group consisting of H₃PO₄, H₂SO₄, HCl, and HI, and may further contain HF. Examples of the etching liquid include an aqueous solution of at least one selected from the group consisting of H₃PO₄, H₂SO₄, HCl, and HI; and a mixed solution of an aqueous solution of HF and an aqueous solution of at least one selected from the group consisting of H₃PO₄, H₂SO₄, HCl, and HI, and particularly include a mixed solution of an aqueous solution of HF and an aqueous solution of at least one selected from the group consisting of H₃PO₄, H₂SO₄, HCl, and HI.

In the etching liquid, the concentration of one selected from the group consisting of H₃PO₄, H₂SO₄, HCl, and HI is 0.1 mol/L or more, preferably 1 mol/L or more, more preferably 2 mol/L or more, still more preferably 3 mol/L or more, and still even more preferably 5 mol/L or more, and may be, for example, 15 mol/L or less, and further 10 mol/L or less. In the etching liquid, the concentration of HF is preferably 1 mol/L or more, more preferably 2 mol/L or more, still more preferably 3 mol/L or more, and still even more preferably 5 mol/L or more, and may be, for example, 15 mol/L or less, and further 10 mol/L or less.

In one embodiment, it is preferable that the concentration of one selected from the group consisting of H₃PO₄, H₂SO₄, HCl, and HI is not less than 1 mol/L and 15 mol/L, and the concentration of HF is not less than 1 mol/L and not more than 15 mol/L; and it is preferable that the concentration of one selected from the group consisting of H₃PO₄, H₂SO₄, HCl, and HI is not less than 3 mol/L and not more than 10 mol/L, and the concentration of HF is not less than 3 mol/L and not more than 10 mol/L.

The etching liquid preferably does not contain a lithium atom. The phrase “does not contain a Li atom” in the etching liquid means that the Li concentration in the etching liquid is less than 20 ppm by mass as measured by, for example, combustion-ion chromatography.

As the etching operation using the etching liquid and other conditions, conventional conditions can be adopted.

### Step (c)

The etched product obtained by the etching treatment is washed with water. By performing water washing, the acid and the like used in the etching treatment can be sufficiently removed. The amount of water to be mixed with the etched product and the washing method are not particularly limited. Examples of the washing method include adding water, and performing stirring, centrifugation, and the like. Examples of the stirring method include handshaking, and stirring using an automatic shaker, a shear mixer, a pot mill, or the like. The degree of stirring such as the stirring speed and the stirring time may be adjusted according to the amount, concentration, and the like of the acid-treated product to be treated. The washing with water may be performed once or more. Washing with water is preferably performed a plurality of times. For example, specifically, steps (i) to (iii) of (i) adding water (to the etched product or the remaining precipitate obtained in the following (iii)) and performing stirring, (ii) centrifuging the stirred product, and (iii) discarding the supernatant after centrifugation are performed within a range of not less than 2 times, for example, and not more than 15 times.

### Step (d)

The first intercalation treatment including a step of mixing the first water washed product obtained by the water washing with a metal-containing compound containing a metal cation is performed. As a result, the metal cation is intercalated between the layers.

The metal cation contains at least one of cations of metals in the third to fifth periods of the periodic table. Examples of the metal of the third period of the periodic table include Na, Mg, Al, and Si. Examples of the metal of the fourth period of the periodic table include K, Ca, Sc, Ti, V, Cr, Mn, Fe, Co, Ni, Cu, Zn, Ga, Ge, and As. Examples of the metal of the fifth period of the periodic table include Rb, Sr, Y, Zr, Nb, Mo, Tc, Ru, Rh, Pd, Ag, Cd, In, Sn, Sb, and Te. The metal may be an alkali metal, an alkaline earth metal, a transition metal (metals of Groups 3 to 11 of the periodic table), or a main group metal (metals of Groups 12 to 16 of the periodic table).

In one aspect, the metal cation preferably contains a cation of one selected from the group consisting of K, Na, Mg, Al, Mn, Ca, Fe, V, Cr, Co, Ni, Zn, Cu, and Sr, and more preferably contains a cation of one selected from the group consisting of K, Na, Mg, Al, Ca, and Sr.

In another aspect, the metal cation preferably contains a cation of one metal selected from the group consisting of K, Na, Mg, Mn, Ca, Fe, Zn and Cu, and more preferably contains a cation of one metal selected from the group consisting of K, Na, and Ca.

The metal of the metal cation may be the same as or different from the metal contained in the MAX phase as a precursor. When the metal of the metal cation is different from the metal contained in the MAX phase as a precursor, it is easy to confirm the presence of the metal in the two-dimensional particle.

Examples of the metal-containing compound containing the metal cation include ionic compounds in which the metal cation is bonded to a cation or an anion. Examples of the ionic compound include a chloride, an iodide, a phosphate, a sulfide salt including a sulfate, a nitrate, an acetate, and a carboxylate of the above metal cations. The metal-containing compound may be a hydrate of the ionic compound.

The content of the metal-containing compound in the formulation for the first intercalation treatment containing the metal-containing compound is preferably 0.001 mass % or more, more preferably 0.01 mass % or more, and still more preferably 0.1 mass % or more. On the other hand, the content of the metal-containing compound in the formulation for the first intercalation treatment is preferably 10 mass % or less, and more preferably 1 mass % or less from the viewpoint of dispersibility in the solution.

The formulation for the first intercalation treatment preferably does not contain a lithium atom. The phrase “does not contain a Li atom” in the formulation for the first intercalation treatment means that the Li concentration in the formulation for the first intercalation treatment is less than 20 ppm by mass as measured by, for example, combustion-ion chromatography.

The specific method of the first intercalation treatment is not particularly limited, and for example, the metal-containing compound may be mixed with the first water washed product, and the mixture may be stirred or left to stand. For example, stirring at room temperature can be exemplified. Examples of the stirring method include a method using a stirring bar of a stirrer or the like, a method using a stirring blade, a method using a mixer, and a method using a centrifugal device. The stirring time can be set according to the production scale of the single-layer/few-layer MXene particle, and can be set, for example, for 12 to 24 hours.

### Step (e)

The first intercalated product obtained by the first intercalation treatment is washed with water. By performing water washing, the excessive metal-containing compound and the like used in the first intercalation treatment can be sufficiently removed. In the first intercalation treatment, the intercalation treatment is performed using a metal-containing compound not containing a Li ion, so that delamination hardly proceeds in the step (e), and the excessive metal-containing compound and the like are washed off.

The amount of water to be mixed with the first intercalated product and the washing method are not particularly limited. Examples of the washing method include adding water, and performing stirring, centrifugation, and the like. Examples of the stirring method include handshaking, and stirring using an automatic shaker, a shear mixer, a pot mill, or the like. The degree of stirring such as the stirring speed and the stirring time may be adjusted according to the amount, concentration, and the like of the acid-treated product to be treated. The washing with water may be performed once or more. Washing with water is preferably performed a plurality of times. For example, specifically, steps (i) to (iii) of (i) adding water (to the etched product or the remaining precipitate obtained in the following (iii)) and performing stirring, (ii) centrifuging the stirred product, and (iii) discarding the supernatant after centrifugation are performed within a range of not less than 2 times, for example, and not more than 15 times.

### Step (f)

A second intercalation treatment including a step of mixing the second water washed product obtained by the water washing with an organic compound that can be dissolved or mixed in water is performed. The organic compound is further intercalated between the layers, and water easily enters between the layers through this treatment, and as a result, delamination can sufficiently proceed in the subsequent delamination step.

The organic compound can be dissolved or mixed in water. The solubility of the organic compound in water is 5 g/100 gH₂O or more, and more preferably 10 g/100 gH₂O or more at 25° C. In the present specification, the solubility in the case of being mixed in water is treated as infinite.

The organic compound is preferably a compound having high polarity. In the present specification, the compound having high polarity is a concept including not only a compound exhibiting clear charge separation but also a compound having high hydrophilicity. The polarity of the compound can be evaluated using a solubility parameter as an index. The Hildebrand solubility parameters (also referred to as “SP value”) of the organic compound are 19.0 MPa^{1/2} or more. The SP value of the organic compound is preferably equal to or less than the SP value of water, and is 47.8 MPa^{1/2} or less. The SP value is a value serving as an index of the polarity of the compound, and as the SP value is larger, the polarity is higher, and compounds having close SP values tend to be compatible with each other.

The boiling point of the organic compound is, for example, 285° C. or lower, preferably 240° C. or lower, more preferably 200° C. or lower, and is, for example, 50° C. or higher.

The molecular weight of the organic compound is, for example, 500 or less, preferably 300 or less, more preferably 200 or less, and is, for example, 30 or more.

Examples of the organic compound include organic compounds having one or more of a carbonyl group, an ester group, an amide group, a formamide group, a carbamoyl group, a carbonate group, an aldehyde group, an ether group, a sulfonyl group, a sulfinyl group, a hydroxyl group, a cyano group, and a nitro group. Specific examples of the organic compound include alcohols such as methanol (MeOH), ethanol (EtOH), and 2-propanol; sulfone compounds such as sulfolane; sulfoxides such as dimethyl sulfoxide (DMSO); carbonates such as propylene carbonate (PC); amides such as N-methylformamide (NMF), N,N-dimethylformamide, N-methylpyrrolidone (NMP), and dimethylacetamide (DMAc); ketones such as acetone and methyl ethyl ketone (MEK); and tetrahydrofuran (THF).

In the formulation for the second intercalation treatment containing an organic compound, the content of the organic compound can be not less than 0.01 parts by mass and not more than 1,000 parts by mass, based on 1 part by mass of the layer portion (MXene layer) of the two-dimensional particle.

The formulation for the second intercalation treatment preferably does not contain a lithium atom. The phrase “does not contain a Li atom” in the formulation for the second intercalation treatment means that the Li concentration in the formulation for the second intercalation treatment is less than 20 ppm by mass as measured by, for example, combustion-ion chromatography.

The specific method of the second intercalation treatment is not particularly limited, and for example, the organic compound may be mixed with the second water washed product, and the mixture may be stirred or left to stand. For example, stirring at room temperature can be exemplified. Examples of the stirring method include a method using a stirring bar of a stirrer or the like, a method using a stirring blade, a method using a mixer, and a method using a centrifugal device. The stirring time can be set according to the production scale of the single-layer/few-layer MXene particle, and can be set, for example, for 12 to 24 hours.

It is preferable that the organic compound is completely removed by washing after the second intercalation treatment, but a small amount of the organic compound may remain to the extent that securing of conductivity is not hindered. The content of the organic compound is preferably 0 mass % when the two-dimensional particle of the present embodiment is measured by gas chromatography-mass spectrometry, and is, for example, more than 0 mass % but not more than 0.01 mass % even when a small amount of the organic compound remains.

### Step (g)

In the step (g), a delamination treatment including a step of stirring the second intercalated product obtained by performing the second intercalation treatment is performed. By the delamination treatment, the MXene particle can be formed into a single layer or a small number of layers.

Conditions for the delamination treatment are not particularly limited, and the delamination treatment can be performed by a known method. Examples of the stirring method include ultrasonic treatment, handshaking, and stirring using an automatic shaker, or the like. The degree of stirring such as the stirring speed and the stirring time may be adjusted according to the amount, concentration, and the like of the treated product to be treated. For example, the slurry after the intercalation is centrifuged, the supernatant is discarded, then pure water is added to the remaining precipitate, and the mixture is stirred by, for example, handshaking or an automatic shaker to perform layer separation. Examples of the removal of the unpeeled substance includes a step of performing centrifugation and discarding the supernatant, and then washing the remaining precipitate with water. For example, (i) pure water is added to the remaining precipitate after discarding the supernatant, and the mixture is stirred, (ii) the stirred mixture is centrifuged, and (iii) the supernatant is recovered. For example, the operations (i) to (iii) may be repeated not less than 1 time, preferably not less than 2 times, and not more than 10 times to obtain a supernatant containing a single-layer/few-layer MXene particle as a delaminated product. Alternatively, the supernatant may be centrifuged, and the supernatant after centrifugation may be discarded to obtain a clay containing a single-layer/few-layer MXene particle as a delaminated product.

Phosphoric acid may be allowed to coexist during the delamination treatment. When phosphoric acid is allowed to coexist, delamination easily proceeds, and particularly when a metal-containing compound containing a polyvalent metal cation is used, delamination can be easily performed. Although not to be construed as being limited to a specific theory, it is considered that the polyvalent metal cation is likely to interact with the layer, and adjacent layers are attracted by stronger force via the polyvalent metal cation. Therefore, usually, delamination hardly proceeds when a metal-containing compound containing a polyvalent metal cation is used. However, it is considered that when phosphoric acid coexists, the phosphoric acid and the polyvalent metal cation can interact with each other, and the interaction between layers via the metal cation is suppressed to some extent. Therefore, it is considered that delamination can proceed even when the metal-containing compound containing a polyvalent metal cation is used.

In the production method of the present embodiment, the ultrasonic treatment is not necessarily performed at the time of the delamination treatment. When the ultrasonic treatment is not performed, breakage of the particle hardly occurs, thus making it is easy to obtain a single-layer/few-layer MXene particle having a large plane parallel to the layer of particle, that is, a large two-dimensional surface.

The delaminated product obtained by stirring can be used as a two-dimensional particle including a single-layer/few-layer MXene particle as it is, and may be washed with water as necessary.

### Embodiment 3: Conductive Film

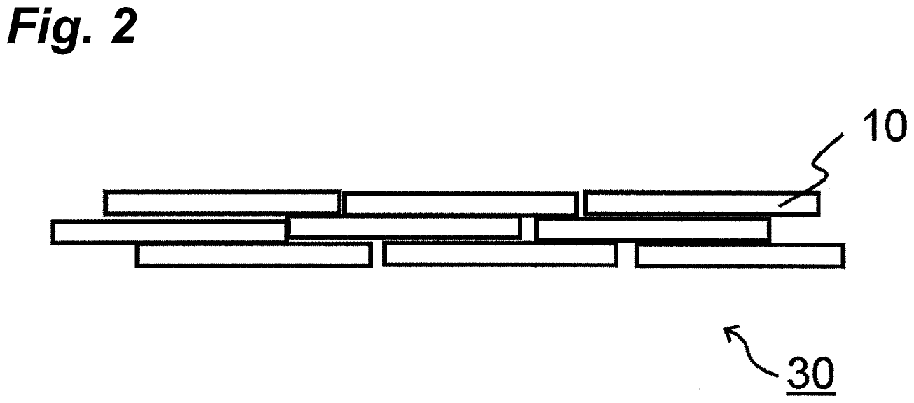

Examples of the application of the two-dimensional particle of the present embodiment include a conductive film containing the two-dimensional particle. A conductive film of the present embodiment will be described with reference to FIG. 2. FIG. 2 illustrates a conductive film 30 obtained by stacking only the two-dimensional particles 10, but the present invention is not limited thereto. The conductive film may contain an additive such as a binder added at the time of film formation, as necessary. The proportion of the additive in the conductive film (dried film) is preferably 30 vol % or less, more preferably 10 vol % or less, still more preferably 5 vol % or less, and most preferably 0 vol %.

As a method for preparing the conductive film without using the binder or the like, the conductive film can be prepared by performing, once or a plurality of times, a step of subjecting the supernatant containing the two-dimensional particles obtained by the delamination to suction filtration, or mixing the two-dimensional particles with a dispersion medium to form a slurry with an appropriate concentration, spraying the slurry, and removing the dispersion medium by drying or the like. The spraying method may be, for example, an airless spray method or an air spray method, and specific examples thereof include a method of spraying using a nozzle such as a one-fluid nozzle, a two-fluid nozzle, or an air brush. Examples of the dispersion medium that can be contained in the slurry include water; and organic media such as N-methylpyrrolidone, N-methylformamide, N,N-dimethylformamide, methanol, ethanol, dimethyl sulfoxide, ethylene glycol, and acetic acid.

Examples of the binder include an acrylic resin, a polyester resin, a polyamide resin, a polyolefin resin, a polycarbonate resin, a polyurethane resin, a polystyrene resin, a polyether resin, and polylactic acid.

The conductivity of the conductive film is preferably 2,000 S/cm or more, more preferably 5,000 S/m or more, and may be, for example, 100,000 S/cm or less, and further 5,0000 S/cm or less.

The conductivity of the conductive film of the present embodiment is determined by substituting the thickness of the conductive film and the surface resistivity of the conductive film measured by the four-point probe method into the following formula.

Conductivity [S/cm]=1/(thickness of conductive film [cm]×surface resistivity of conductive film [Ω/square])

Examples of other applications using the two-dimensional particle of the present embodiment include a conductive paste containing the two-dimensional particle, a resin, and an additive (dispersion medium, viscosity modifier, and the like) to be used as necessary, and a conductive composite material containing the two-dimensional particle and a resin. These are also suitable for applications in which high conductivity is required to be maintained even under high humidity conditions.

Examples of the resin that can be contained in the conductive paste and the conductive composite material include the same resins as the resins that can be contained in the conductive film. Examples of the dispersion medium that can be contained in the conductive paste include water; and organic media such as N-methylpyrrolidone, N-methylformamide, N,N-dimethylformamide, methanol, ethanol, dimethyl sulfoxide, ethylene glycol, and acetic acid.

Although the two-dimensional particle in one embodiment of the present invention has been described in detail above, various modifications are possible. The two-dimensional particle of the present invention may be produced by a method different from the production method in the above embodiment, and the production method of the two-dimensional particle of the present invention is not limited only to those that provide the two-dimensional particle in the above embodiment.

### EXAMPLES

### Examples 1 to 5 and 13

### [Production of Two-Dimensional Particles]

In Examples 1 to 5, (1) preparation of the precursor (MAX), (2) etching of the precursor, (3) first washing, (4) first intercalation, (5) second washing, (6) second intercalation, (7) delamination, and (8) water washing, which are to be described in detail below, were sequentially performed to prepare two-dimensional particles.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The obtained calcined body (block) was crushed with an end mill to a maximum size of 40 μm or less. In this way, Ti₃AlC₂ particles were obtained as a precursor (MAX).

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieved with a mesh size of 45 μm)
See Table 1 for etching liquid composition
Amount of precursor input: 3.0 g
Etching container: 100 mL Iboy
Etching temperature: 35° C.
Etching time: 24 hours
Stirrer rotation speed: 400 rpm

### (3) First Washing

The slurry was divided into two portions, each of which was inserted into two 50 mL centrifuge tubes, and centrifuged using a centrifuge under the conditions of 3,500 G and 5 minutes, and then the supernatant was discarded. An operation of adding 35 mL of pure water to each centrifuge tube, and performing centrifugation again at 3,500 G for 5 minutes to separate and remove the supernatant was repeated 11 times. After final centrifugation, the supernatant was discarded to obtain a Ti₃C₂ Tₛ-moisture medium clay.

### (4) First Intercalation

To the Ti₃C₂ Tₛ-moisture medium clay prepared by the above method, 20 mL of pure water and each of the metal-containing compounds shown in Table 1 were added, and the mixture was stirred at not lower than 20° C. and not higher than 25° C. for 15 hours to perform the first intercalation using a metal cation as an intercalator. Detailed conditions of the first intercalation are as follows.

### (Conditions of First Intercalation)

Ti₃C₂ Tₛ-moisture medium clay (MXene after washing): solid content 0.5 g
See Table 1 for the metal-containing compound and the added amount.
Intercalation container: 100 mL Iboy
Temperature: not lower than 20° C. and not higher than 25° C. (room temperature)
Time: 15 hours
Stirrer rotation speed: 700 rpm

### (5) Second Washing

The slurry was inserted into a 50 mL centrifuge tube, 10 mL of pure water was added, this was centrifuged using a centrifuge under the conditions of 3,500 G and 5 minutes, and then the supernatant was discarded. An operation of adding 35 mL of pure water to the centrifuge tube from which the supernatant has been discarded, and performing centrifugation again at 3,500 G for 5 minutes to separate and remove the supernatant was repeated 3 times. After final centrifugation, the supernatant was discarded to obtain an MXene clay.

### (6) Second Intercalation

The MXene clay prepared by the above method was stirred at not lower than 20° C. and not higher than 25° C. for 11 hours using each of the organic compounds shown in Table 1 to perform the second intercalation using an organic compound as an intercalator. Detailed conditions of the second intercalation are as follows.

### (Conditions of Second Intercalation)

MXene clay: solid content 0.5 g
See Table 1 for the organic compound and the added amount
Intercalation container: 100 mL Iboy
Temperature: not lower than 20° C. and not higher than 25° C. (room temperature)
Time: 11 hours
Stirrer rotation speed: 700 rpm

### (7) Delamination

The slurry obtained by performing the second intercalation was charged into a 50 mL centrifuge tube, 20 mL of pure water was added, and this was centrifuged using a centrifuge under the conditions of 3,500 G and 5 minutes, and then the supernatant was recovered. Further, an operation of adding 35 mL of pure water, stirring the mixture with a shaker for 15 minutes, performing centrifugation at 3,500 G for 5 minutes, and recovering the supernatant as a single-layer MXene particle-containing liquid was repeated 4 times to obtain a single-layer MXene particle-containing supernatant. Further, this supernatant was centrifuged using a centrifuge under the conditions of 4,300 G and 2 hours, and then the supernatant was discarded to obtain a clay containing two-dimensional particles (single-layer MXene particles).

### Examples 6, 7, 9, and 10

A precursor (MAX) was prepared in the same manner as in Examples 1 to 5, then the following step (2) was performed, and the first washing, first intercalation, second washing, second intercalation, and delamination were performed on the obtained solid-liquid mixture (slurry) containing a solid component derived from Ti₃AlC₂ powder in the same manner as in Examples 1 to 5, to prepare a clay containing two-dimensional particles (single-layer MXene particles).
(1) Preparation of Precursor (MAX): Same as in Examples 1 to 5
(2) Etching of Precursor

Using the Ti₃AlC₂ particles (powder) prepared in the above step (1), etching was performed under the following etching conditions to obtain a solid-liquid mixture (slurry) containing a solid component derived from the Ti₃AlC₂ powder.

### (Etching Conditions)

Precursor: Ti₃AlC₂ (sieved with a mesh size of 45 μm)
See Table 1 for etching liquid composition
Amount of precursor input: 3.0 g
Etching container: 100 mL Iboy
Etching temperature: 35° C.
Etching time: 24 h
Stirrer rotation speed: 400 rpm
(3) First washing: same as in Examples 1 to 5
(4) First intercalation: same as in Examples 1 to 5
(5) Second washing: same as in Examples 1 to 5
(6) Second intercalation: same as in Examples 1 to 5
(7) Delamination: same as in Examples 1 to 5

### Example 8

The preparation of the precursor (MAX), etching, first washing, first intercalation, second washing, and second intercalation were performed in the same manner as in Examples 1 to 5, and then the following step (7) was performed to prepare a clay containing two-dimensional particles (single-layer MXene particles).
(1) Preparation of precursor (MAX): same as in Examples 1 to 5
(2) Etching of precursor: same as in Examples 1 to 5
(3) First washing: same as in Examples 1 to 5
(4) First intercalation: same as in Examples 1 to 5
(5) Second washing: same as in Examples 1 to 5
(6) Second intercalation: same as in Examples 1 to 5
(7) Delamination

The slurry obtained by performing the second intercalation was charged into a 50 mL centrifuge tube, 5 g of an aqueous phosphoric acid solution (0.85 mass %) was added thereto, and the mixture was stirred by handshaking. Thereafter, 5 mL of pure water was added, and this was centrifuged using a centrifuge under the conditions of 3,500 G and 5 minutes, and then the supernatant was recovered. Further, 35 mL of pure water was added, then the mixture was stirred for 15 minutes with a shaker, and then centrifuged at 3,500 G for 5 minutes to obtain a single-layer MXene particle-containing liquid as a supernatant. Further, the single-layer MXene particle-containing liquid was centrifuged using a centrifuge under the conditions of 4,300 G and 2 hours, and then the supernatant was discarded to obtain a clay containing two-dimensional particles (single-layer MXene particles).

### Examples 11 and 12

The preparation of the precursor (MAX) was performed in the same manner as in Examples 1 to 5, then the following step (2) was performed, and the first washing, first intercalation, second washing, and second intercalation were performed on the obtained solid-liquid mixture (slurry) containing a solid component derived from Ti₃AlC₂ powder in the same manner as in Examples 1 to 5, then the following step (7) was performed, to prepare a clay containing two-dimensional particles (single-layer MXene particles).

The preparation of the precursor (MAX), etching, first washing, first intercalation, second washing, and second intercalation were performed in the same manner as in Examples 1 to 5, and then the following step (7) was performed to prepare a clay containing two-dimensional particles (single-layer MXene particles).
(1) Preparation of precursor (MAX): same as in Examples 1 to 5
(2) Etching of precursor

Using the Ti₃AlC₂ particles (powder) prepared in the above step (1), etching was performed under the following etching conditions to obtain a solid-liquid mixture (slurry) containing a solid component derived from the Ti₃AlC₂ powder.

### (Etching Conditions)

Precursor: Ti₃AlC₂ (sieved with a mesh size of 45 μm)
See Table 1 for etching liquid composition
Amount of precursor input: 3.0 g
Etching container: 100 mL Iboy
Etching temperature: 35° C.
Etching time: 24 h
Stirrer rotation speed: 400 rpm
(3) First washing: same as in Examples 1 to 5
(4) First intercalation: same as in Examples 1 to 5
(5) Second washing: same as in Examples 1 to 5
(6) Second intercalation: same as in Examples 1 to 5
(7) Delamination

The slurry obtained by performing the second intercalation was charged into a 50 mL centrifuge tube, 5 g of an aqueous phosphoric acid solution (0.85 mass %) was added thereto, and the mixture was stirred by handshaking. Thereafter, 20 mL of each of the organic compounds in Table 1 was added, and this was centrifuged using a centrifuge under the conditions of 3,500 G and 5 minutes, and then the supernatant was recovered. Further, 35 mL of each of the organic compounds was added, then the mixture was stirred for 15 minutes with a shaker, and then centrifuged at 3,500 G for 5 minutes to obtain a single-layer MXene particle-containing liquid as a supernatant. Further, the single-layer MXene particle-containing liquid was centrifuged using a centrifuge under the conditions of 4,300 G and 2 hours, and then the supernatant was discarded to obtain a clay containing two-dimensional particles (single-layer MXene particles).

### Comparative Example 1

After (1) preparation of the precursor (MAX) was performed in the same manner as in Examples 1 to 5, (2) etching of the precursor and Li intercalation, (3) washing, and (4) delamination were performed as follows without performing intercalation using an organic compound as an intercalator, to prepare a single-layer/few-layer MXene particle-containing sample.
(1) Preparation of precursor (MAX): same as in Examples 1 to 5
(2) Etching of precursor and Li intercalation

Using the Ti₃AlC₂ particles (powder) prepared by the above method, etching and Li intercalation were performed under the following conditions to obtain a solid-liquid mixture (slurry) containing a solid component derived from the Ti₃AlC₂ powder.

### (Conditions of Etching and Li Intercalation)

Precursor: Ti₃AlC₂ (sieved with a mesh size of 45 μm)
Etching liquid composition: LiF 3 g

HCl (9M) 30 mL
Amount of precursor input: 3 g
Etching container: 100 mL Iboy
Etching temperature: 35° C.
Etching time: 24 h
Stirrer rotation speed: 400 rpm
(3) Washing

The slurry was divided into two portions, each of which was inserted into two 50 mL centrifuge tubes, and centrifuged using a centrifuge under the condition of 3,500 G, and then the supernatant was discarded. (i) 40 mL of pure water was added to the remaining precipitate in each centrifuge tube, (ii) centrifugation was performed again at 3,500 G, and (iii) the supernatant was separated and removed. The operations (i) to (iii) were repeated 10 times in total, it was confirmed that the pH of the supernatant at the 10th time was more than 5, and the supernatant was discarded to obtain a Ti₃C₂ Tₛ-moisture medium clay.

### (4) Delamination

(i) 40 mL of pure water was added to the Ti₃C₂ Tₛ-moisture medium clay, then the mixture was stirred with a shaker for 15 minutes, (ii) the mixture was centrifuged at 3,500 G, and (iii) the supernatant was recovered as a single-layer MXene particle-containing liquid. The operations (i) to (iii) were repeated 4 times in total to obtain a single-layer MXene particle-containing supernatant. Further, this supernatant was centrifuged using a centrifuge under the conditions of 4,300 G and 2 hours, and then the supernatant was discarded to obtain a single-layer/few-layer MXene particle-containing clay as a single-layer/few-layer MXene particle-containing sample.

### Comparative Example 2

After (1) preparation of the precursor (MAX) was performed in the same manner as in Examples 1 to 5, (2) etching, (3) washing, (4) TMAOH intercalation, and (5) delamination were performed as follows to obtain a single-layer/few-layer MXene particle-containing clay.

### (1) Preparation of Precursor (MAX): Same as in Examples 1 to 5

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieved with a mesh size of 45 μm)
Etching liquid composition: 49% HF 25 mL,

H₂O 25 mL
Amount of precursor input: 3.0 g
Etching container: 100 mL Iboy
Etching temperature: not lower than 20° C. and not higher than 25° C. (room temperature)
Etching time: 24 h
Stirrer rotation speed: 400 rpm

### (3) Washing

The slurry was divided into two portions, each of which was inserted into two 50 mL centrifuge tubes, and centrifuged using a centrifuge under the condition of 3,500 G, and then the supernatant was discarded. An operation of adding 40 mL of pure water to each centrifuge tube, and performing centrifugation again at 3,500 G to separate and remove the supernatant was repeated 11 times. After final centrifugation, the supernatant was discarded to obtain a Ti₃C₂ Tₛ-moisture medium clay as the remaining precipitate.

### (4) TMAOH Intercalation

The Ti₃C₂ Tₛ-moisture medium clay prepared by the above method was stirred at not lower than 20° C. and not higher than 25° C. for 12 hours using TMAOH as an intercalator under the following conditions of TMAOH intercalation to perform TMAOH intercalation.

### (Conditions of TMAOH Intercalation)

Ti₃C₂ Tₛ-moisture medium clay (MXene after washing): solid content 1.0 g
TMAOH 5H₂O: 1.98 g
Pure water: 100 mL
Intercalation container: 250 mL Iboy
Temperature: not lower than 20° C. and not higher than 25° C. (room temperature)
Time: 12 h
Stirrer rotation speed: 800 rpm

### (5) Delamination

The slurry obtained by TMAOH intercalation was divided into two portions, each of which was inserted into two 50 mL centrifuge tubes, and centrifuged using a centrifuge under the condition of 3,500 G, and the supernatant was recovered. An operation of adding 40 mL of pure water to each centrifuge tube, performing centrifugation again at 3,500 G, and recovering the supernatant was repeated 2 times to obtain a single-layer/few-layer MXene particle-containing supernatant. The single-layer/few-layer MXene particle-containing supernatant was centrifuged at 3,500 G for 1 hour using a centrifuge to precipitate single-layer/few-layer MXene particles to obtain a single-layer/few-layer MXene particle-containing clay.

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Etching | 49% aqueous HF | mL | 6 | 6 | 6 | 6 | 6 | 15 | 15 | 6 | 6 | 6 |
| liquid | solution | | | | | | | | | | | |
| composition | 58% aqueous HI | mL | | | | | | | | | 32 | |
| | solution | | | | | | | | | | | |
| | 37% aqueous HCl | mL | 36 | 36 | 36 | 36 | 36 | | | 36 | | |
| | solution | | | | | | | | | | | |
| | 85% aqueous | mL | | | | | | 15 | 15 | | | |
| | H₃PO₄ solution | | | | | | | | | | | |
| | 95% H₂SO₄ | mL | | | | | | | | | | 24 |
| | aqueous solution | | | | | | | | | | | |
| | H₂O | mL | 18 | 18 | 18 | 18 | 18 | 30 | 30 | 18 | 6 | 30 |
| Etching and | LiF | g | | | | | | | | | | |
| intercalation | 9M aqueous HCl | mL | | | | | | | | | | |
| | solution | | | | | | | | | | | |
| Metal- | NaCl | g | 0.72 | | 0.72 | | 0.72 | 0.72 | | | 0.72 | 0.72 |
| containing | KCl | g | | 0.91 | | 0.91 | | | 0.91 | | | |
| compound | CaCl₂ | g | | | | | | | | 1.58 | | |
| | MgCl₂ | g | | | | | | | | | | |
| | SrCl₂•6H₂O | g | | | | | | | | | | |
| | AlCl₃•6H₂O | g | | | | | | | | | | |
| Organic | NMF | mL | 20 | 20 | | | | 20 | 20 | 20 | 20 | 20 |
| compound | DMSO | mL | | | 20 | | | | | | | |
| | DMF | mL | | | | 20 | | | | | | |
| | MeOH | mL | | | | | 20 | | | | | |

TABLE 2

| | | | Example | Example | Example | Comparative | Comparative |
|---|---|---|---|---|---|---|---|
| | | | 11 | 12 | 13 | Example 1 | Example 2 |
| Etching | 49% aqueous HF | mL | 6 | 6 | 6 | | 25 |
| liquid | solution | | | | | | |
| composition | 58% aqueous HI | mL | | | | | |
| | solution | | | | | | |
| | 37% aqueous HCl | mL | 54 | 54 | 36 | | |
| | solution | | | | | | |
| | 85% aqueous | mL | | | | | |
| | H₃PO₄ solution | | | | | | |
| | 95% H₂SO₄ | mL | | | | | |
| | aqueous solution | | | | | | |
| | H₂O | mL | | | 18 | | 25 |
| Etching and | LiF | g | | | | 3 | |
| intercalation | 9M aqueous HCl | mL | | | | 30 | |
| | solution | | | | | | |
| Metal- | NaCl | g | | | | | |
| containing | KCl | g | | | | | |
| compound | CaCl₂ | g | | | | | |
| | MgCl₂ | g | 1.17 | | | | |
| | SrCl₂•6H₂O | g | | 1.51 | | | |
| | AlCl₃•6H₂O | g | | | 2.96 | | |
| Organic | NMF | mL | 20 | 20 | 20 | | |
| compound | DMSO | mL | | | | | |
| | DMF | mL | | | | | |
| | MeOH | mL | | | | | |

### (Conductive Film Preparation Method)

The clay containing two-dimensional particles (single-layer MXene particles) obtained in each of Examples 1 to 10 and Comparative Examples 1 and 2 was subjected to suction filtration. After the filtration, vacuum drying was performed at 80° C. for 24 hours to prepare a conductive film containing two-dimensional particles. As the filter for suction filtration, a membrane filter (Durapore, manufactured by Merck KGaA, pore size: 0.45 μm) was used. The supernatant contained 0.05 g of solid content of two-dimensional particles and 40 mL of pure water.

### (Method for Detecting Elements on Layer Surface)

The obtained conductive film containing two-dimensional particles was measured by X-ray photoelectron spectroscopy (XPS), and the organic compound contained in the two-dimensional particles and elements on the layer surface were detected. Quantum 2000 manufactured by ULVAC-PHI, Inc. was used for the XPS measurement.

### (Method for Detecting Metal Cation)

A solution obtained by dissolving the obtained two-dimensional particles according to the alkali fusion method was measured by inductively coupled plasma atomic emission spectroscopy (ICP-AES), and metal cations contained in the two-dimensional particles were detected. For the ICP-AES measurement, iCAP7400 manufactured by Thermo Fisher Scientific Inc. was used.

### (Detection of Organic Compound)

The obtained two-dimensional particles were measured by gas chromatography-mass spectrometry (GC-MS), and the presence of the organic compound was confirmed. For the GC-MS measurement, a gas chromatography mass spectrometry (GCMS) apparatus (Aglient 5975C) manufactured by Agilent Technologies, Inc. was used.

### (Measurement of Average Value of Major Diameters of Two-Dimensional Surfaces of Two-Dimensional Particles)

A slurry prepared by dispersing two-dimensional particles in water was applied to a silicon substrate and dried, and a scanning electron microscope (SEM) photograph was taken to perform measurement. The magnification was set to 2,000 times, and 80 or more of two-dimensional particles (MXene particles) that can be visually confirmed in one or more SEM image fields (about 1 to 3 fields) having a field size of 45 μm×45 μm were measured as a target. The shape of the two-dimensional surface of each two-dimensional particle (MXene particle) (shape viewed from a direction orthogonal to the layer of each two-dimensional particle) was approximated to an elliptical shape, and the major diameter thereof was measured. The average value of the major diameters measured for the two-dimensional particles (MXene particles) as a target was taken as the average value of the major diameters of the two-dimensional surfaces of the two-dimensional particles. SEM image analysis software “A-Zou Kun” (registered trademark, manufactured by Asahi Kasei Engineering Corporation) was used for approximation to the elliptical shape. When a silicon substrate is used as a substrate, fine black spots in the micrograph may be derived from the substrate. Therefore, before the image analysis, processing of removing the background porous portion by image processing was performed as necessary.

### (Measurement of Average Value of Thicknesses of Two-Dimensional Particles)

One or more photographs with a field size of 50 μm×50 μm were taken using an atomic force microscope (AFM), the thicknesses of freely selected 80 two-dimensional particles as a target were obtained in each photograph, and the average value of the 80 two-dimensional particles was determined and taken as the average thickness.

### (Method for Measuring Conductivity of Conductive Film)

The conductivity of the obtained conductive film containing two-dimensional particles was determined. For the conductivity, the resistivity (Q) and the thickness (m) were measured at three points per sample, the conductivity (S/cm) was calculated from these measured values, and the average value of three conductivities obtained by this calculation was adopted. For resistivity measurement, the surface resistance of the conductive film was measured by four-terminal sensing using a simple low resistivity meter (Loresta AX MCP-T370, manufactured by Mitsubishi Chemical Analytech Co., Ltd.). A micrometer (MDH-25 MB, manufactured by Mitutoyo Corporation) was used for the thickness measurement. Then, the volume resistivity was determined from the obtained surface resistance and the thickness of the conductive film, and the conductivity was determined by taking the reciprocal of the value of the volume resistivity, and defined as E₀.

### (Method for Measuring Conductivity Change Rate)

A conductive film was placed in a thermo-hygrostat set at a relative humidity of 99% and a temperature of 25° C. After standing for 7 days, the conductivity was measured and defined as E. The conductivity change rate was obtained by dividing E by E₀.

### (Confirmation of Existence Form of Al Cations)

The two-dimensional particles obtained in Example 13 were mixed with KBr having a mass ratio of about 9 times in a glove box in an Ar atmosphere. Then, the mixture was filled in a 4 mm sample tube made of zirconia, and solid ²⁷Al NMVR measurement was performed to obtain a one-dimensional NMR spectrum. In addition, Ti₃AlC₂, AlCl₃·6H₂O, Al₂O₃, and AlF₃ were also measured in the same manner.

The measurement conditions in ²⁷Al NMR measurement were as follows.

Observation nucleus: ²⁷ Al

Measurement method: magic angle spinning+Hahn echo method

MAS spinning speed: 12 kHz

Integrated delay time: 0.1 seconds

Number of scans: 160,000

Table 2 shows the measurement results of the types of elements on the layer surface, the type of the metal cation, the type of the organic low molecular weight compound, the average particle size, the average thickness, the conductivity, and the conductivity change rate.

TABLE 3

| | Components in two-dimensional particle | | | | | | Conductivity |
|---|---|---|---|---|---|---|---|
| | | | Organic low | Average | Average | Conductivity | change rate |
| | Elements on | Metal | molecular weight | particle size | thickness | [E₀] | [E/E₀] |
| | layer surface | cation | compound | (μm) | (nm) | (S/cm) | (%) |
| Example 1 | F, O, Cl | Na | NMF | 3.2 | 1.7 | 4,400 | 65 |
| Example 2 | F, O, Cl | K | NMF | 3.5 | 2.4 | 5,900 | 67 |
| Example 3 | F, O, Cl | Na | DMSO | 1.9 | 2.5 | 4,600 | 63 |
| Example 4 | F, O, Cl | K | DMF | 2.2 | 3.2 | 5,000 | 70 |
| Example 5 | F, O, Cl | Na | MeOH | 2.1 | 2.4 | 4,900 | 63 |
| Example 6 | F, O, P | Na | NMF | 2.4 | 2.8 | 5,400 | 69 |
| Example 7 | F, O, P | K | NMF | 3.2 | 2.9 | 6,600 | 74 |
| Example 8 | F, O, Cl | Ca | NMF | 1.2 | 4.8 | 4,700 | 66 |
| Example 9 | F, O, I | Na | NMF | 3.6 | 3.3 | 4,900 | 70 |
| Example 10 | F, O, S | Na | NMF | 4.3 | 4.1 | 5,000 | 68 |
| Example 11 | F, O, Cl | Mg | NMF | 3.1 | 3.1 | 4,000 | 60 |
| Example 12 | F, O, Cl | Sr | NMF | 3.5 | 3.1 | 4,500 | 70 |
| Example 13 | F, O, Cl | Al | NMF | 3.3 | 3.2 | 4,900 | 25 |
| Comparative | F, O, Cl | Li | — | 1.3 | 3.0 | 4,900 | 27 |
| Example 1 | | | | | | | |
| Comparative | F, O | — | — | 0.1 | 4.3 | 1,000 | 36 |
| Example 2 | | | | | | | |

From the results in Table 1 above, the MXene two-dimensional particles obtained in the present embodiment did not contain Li, and were capable of maintaining high conductivity even under high humidity conditions. In Examples 6 and 7, it was confirmed that P was contained as an element on the layer surface, and PO₄³⁻ was bonded to M of the layer of MXene two-dimensional particles. In Example 10, it was confirmed that S was contained as an element on the layer surface, and SO₄²⁻ was bonded to M of the layer of MXene two-dimensional particles. In addition, in the MXene two-dimensional particles obtained in the present embodiment, the average value of the major diameters of the two-dimensional surfaces was 1 μm or more, and the average value of the thicknesses was 10 nm or less. Therefore, a film (conductive film) that can be handled without adding a binder could be produced using the MXene two-dimensional particles obtained in the present embodiment. In addition, since the average value of the major diameters of the two-dimensional surfaces of the MXene two-dimensional particles was as large as 1 μm, the obtained film (conductive film) exhibited high conductivity.

With respect to the content of Al, the content of Al in the two-dimensional particle of Example 13 was 0.43 mass %, and it was confirmed that the content of Al was greatly increased as compared with 0.02 mass % in Comparative Example 1 in which the compound containing Al was not used as the metal-containing compound. In the spectrum obtained by measurement of ²⁷Al NMR, it was confirmed that Al contained in the two-dimensional particle of Example 13 had a peak around −15.6 ppm.

It was confirmed that the peak of Ti₃AlC₂ in the NMR spectrum was around 113.2 ppm, and the peak of AlCl₃·6H₂O in the NMR spectrum was around −1.3 ppm. Therefore, it is considered that Al contained in the two-dimensional particle of Example 13 is present in a state different from Al in the precursor and Al in the metal-containing compound. In addition, it was confirmed that the peak of Al₂O₃ in the NMR spectrum was around 12.8 ppm. It is considered that Al₂O₃ may be generated when Al is not intercalated between layers and forms an oxide alone. From the above measurement results, it is considered that in the two-dimensional particle of Example 3, Al is present inside the two-dimensional particle, that is, between layers.

Meanwhile, it was confirmed that the peak of AlF₃ in the NMR spectrum was around 16.2 ppm, and AlF₃ was present at a position close to the peak of Al in the two-dimensional particle of Example 13. Since AlF₃ is an ionic compound, it is considered that Al contained in the two-dimensional particle of Example 13 is also present as an ion (metal cation).

On the other hand, in Comparative Example 1, since Li was used as an intercalator, the conductivity was significantly reduced under high humidity conditions. In Comparative Example 2, no metal cation was contained, and TMAOH having low conductivity remained in the MXene particle, so that the conductivity of the film was low.

The two-dimensional particle, the conductive film, and the conductive paste of the present invention may be utilized for any suitable application, and can be particularly preferably used, for example, as electrodes in electrical devices.

### EXPLANATION OF REFERENCES

1a, 1b Layer body (MₘXₙ layer)
3a, 5a, 3b, 5b Modifier or terminal T
7a, 7b MXene layer
10, 10a, 10b MXene particle (two-dimensional particle composed of layered material)
30 Conductive film

1. A two-dimensional particle comprising:
one or more layers, wherein each of the one or more layers includes a layer body represented by:
MₘXₙ
wherein M is at least one Group 3, 4, 5, 6, or 7 metal,
X is a carbon atom, a nitrogen atom, or a combination thereof,
n is not less than 1 and not more than 4,
m is more than n but not more than 5, and
a modifier or terminal T is present on a surface of the layer body, wherein T is at least one selected from the group consisting of a hydroxy group, a fluorine atom, a bromine atom, an oxygen atom, a sulfur atom, Se, Te, and a hydrogen atom,
wherein the M of the one or more layers is bonded to at least one selected from the group consisting of PO₄³⁻ and SO₄²⁻; and
a metal cation of metals in the third to fifth periods of the periodic table, and
wherein a content of Li in the two-dimensional particle is less than 0.002 mass %.

2. The two-dimensional particle according to claim 1, wherein the metal cation is of at least one metal selected from the group consisting of K, Na, Mg, Al, Mn, Ca, Fe, V, Cr, Co, Ni, Zn, Cu, and Sr.

3. The two-dimensional particle according to claim 1, wherein the metal cation is of at least one metal selected from the group consisting of K, Na, Mg, Al, Ca, and Sr.

4. The two-dimensional particle according to claim 1, wherein the content of the Li in the two-dimensional particle is 0.0001 mass % or less.

5. The two-dimensional particle according to claim 1, wherein a content of Al is 0.4 mass % or more.

6. The two-dimensional particle according to claim 1, wherein an Al cation is present between the one or more layers.

7. The two-dimensional particle according to claim 1, wherein an average thickness is not less than 1 nm and not more than 10 nm.

8. The two-dimensional particle according to claim 1, wherein an average value of major diameters of two-dimensional surfaces is not less than 1 μm and not more than 20 μm.

9. The two-dimensional particle according to claim 1, wherein the metal cation is on the one or more layers.

10. The two-dimensional particle according to claim 1, wherein a content of the metal cation in the two-dimensional particle is 20 mass % or less.

11. A conductive film comprising the two-dimensional particle according to claim 1.

12. The conductive film according to claim 11, wherein a conductivity of the conductive film is 2,000 S/cm or more.

13. A conductive paste comprising the two-dimensional particle according to claim 1 and a dispersion medium.

14. A method for producing a two-dimensional particle, the method comprising:
(a) preparing a precursor represented by:
MₘAXₙ
wherein M is at least one Group 3, 4, 5, 6, or 7 metal,
X is a carbon atom, a nitrogen atom, or a combination thereof,
A is at least one group 12, 13, 14, 15, 16 element,
n is not less than 1 and not more than 4, and
m is more than n but not more than 5;
(b) performing an etching treatment for removing at least a part of the A atoms from the precursor using an etching liquid to obtain an etched product, wherein the etching liquid contains an anion containing at least one selected from the group consisting of a phosphorus atom, a sulfur atom, a chlorine atom, and an iodine atom;
(c) performing a first water washing treatment including washing the etched product with water to obtain a first water washed product;
(d) performing a first intercalation treatment including mixing the first water washed product with a metal-containing compound to obtain a first intercalated product, wherein the metal-containing compound contains at least one of cations of metals in the third to fifth periods of the periodic table;
(e) performing a second water washing treatment including washing the first intercalated product with water to obtain a second water washed product;
(f) performing a second intercalation treatment including mixing the second water washed product with an organic compound to obtain a second intercalated product, wherein a solubility of the organic compound in water is 5 g/100 gH₂O or more at 25° C.; and
(g) performing a delamination treatment including stirring the second intercalated product to obtain a two-dimensional particle.

15. The method for producing a two-dimensional particle according to claim 14, wherein the delamination treatment includes stirring the second intercalated product in the presence of PO₄³⁻.

16. The method for producing a two-dimensional particle according to claim 14, wherein a Hildebrand solubility parameter of the organic compound is not less than 19.0 MPa^{1/2} and not more than 47.8 MPa^{1/2}.

17. The method for producing a two-dimensional particle according to claim 14, wherein the metal cation is of at least one metal selected from the group consisting of K, Na, Mg, Al, Mn, Ca, Fe, V, Cr, Co, Ni, Zn, Cu, and Sr.

18. The method for producing a two-dimensional particle according to claim 14, wherein the metal cation is of at least one metal selected from the group consisting of K, Na, Mg, Al, Ca, and Sr.

19. The method for producing a two-dimensional particle according to claim 14, wherein the solubility of the organic compound in water is 10 g/100 gH₂O or more at 25° C.
